(19) United States
(12) Patent Application Publication
(10) Pub. No.: US 2013/0339256 A1
(43) Pub. Date: Dec. 19, 2013

(54) SYSTEM AND METHOD FOR PROVIDING VIRTUAL ARBITRATION

(71) Applicant: Shardul Suresh Shroff, New Delhi (IN)

(72) Inventor: Shardul Suresh Shroff, New Delhi (IN)

(73) Assignee: Shardul Suresh Shroff, New Delhi (IN)

(21) Appl. No.: 13/988,011

(22) PCT Filed: Nov. 16, 2011
(86) PCT No.: PCT/IN11/00792

§ 371 Date: Sep. 3, 2013

(30) Foreign Application Priority Data
Nov. 16, 2010 (IN) 2725/DEL/2010

(51) Int. Cl. G06Q 50/18; H04L 29/06

(52) U.S. Cl. CPC G06Q 50/182; H04L 65/403
USPC 705/309

(57) ABSTRACT

A system for facilitating users to perform automated arbitration proceeding over a communication network via a virtual arbitration centre in a cloud computing environment is provided. The system comprises virtual arbitration modules in the virtual arbitration centre to provide cloud-based arbitration service over the communication network to users at remote locations. The system further comprises electronic devices to facilitate the users to access the cloud-based virtual arbitration service via a web-based user interface on the electronic devices. The virtual arbitration modules comprise a cloud-based repository configured to store predetermined rules and data related to arbitration. The virtual arbitration modules further comprise a case management module to facilitate secure cloud-based communication of the arbitration related data between the users and to facilitate the users to conduct an auto mated online arbitration proceeding by performing cloud computing on the arbitration related data and the predetermined rules employing cloud computing components.

### FIELD OF THE INVENTION

The present invention relates generally to the field of online dispute resolution and more particularly to a system and method for providing secure online arbitration over a communication network.

### BACKGROUND OF THE INVENTION

With increase in number of legal dispute cases being filed in courts, alternative dispute resolution services are widely adopted for resolving legal disputes outside courts. An example of an alternative dispute resolution process is an arbitration process where a neutral party (i.e. arbitrator(s)) decides disputes between parties by passing an arbitral award upon examination of the parties pleadings, and evidence (if any) after conducting a hearing. Conventionally, arbitration proceedings require all parties, witnesses, arbitrators and lawyers to be at a single geographical location for resolving disputes. In certain scenarios, parties may have to travel distances which result in loss of time and money and may in turn cause inconvenience to the parties.

In light of the above, there is a need for a system and method that facilitates conducting arbitration proceedings electronically via an online arbitration centre. Further, there is a need for a system and method that provides a virtual arbitration process using secure technologies. Also, there is a need for a system and method that facilitates parties to attend virtual arbitration proceedings from anywhere in the world irrespective of geographical boundaries. Further, there is a need for a cost-effective system and method that facilitates an automated arbitration process which minimizes tedious and time consuming activities which the parties are required to accomplish. In addition, there is a need for a system and method that stores data related to ongoing arbitration in a cloud computing architecture thereby denuding the arbitration centre of territorial linkage to any jurisdiction.

### SUMMARY OF THE INVENTION

A system for facilitating users to perform automated arbitration proceeding over a communication network via a virtual arbitration centre is provided. In various embodiments of the present invention, the system comprises one or more virtual arbitration modules configured to provide users at remote locations access to the virtual arbitration centre via a web-based user interface on the users' electronic devices. The one or more virtual arbitration modules comprises a cloud-based repository configured to store one or more predetermined rules and data related to arbitration. Further, the one or more virtual arbitration modules comprises a case management module configured to facilitate secure communication of the arbitration related data between the users and further configured to facilitate the users to conduct an automated online arbitration proceeding using the data related to arbitration and the one or more predetermined rules.

A system for facilitating users to perform automated arbitration proceeding over a communication network via a virtual arbitration centre in a cloud computing environment is provided. The system comprises one or more virtual arbitration modules in the virtual arbitration centre configured to provide cloud-based arbitration service over the communication network to users at remote locations. The system further comprises one or more electronic devices configured to facilitate the users to access the cloud-based virtual arbitration service via a web-based user interface on the one or more electronic devices. The one or more virtual arbitration modules comprises a cloud-based repository configured to store one or more predetermined rules and data related to arbitration. Further, the one or more virtual arbitration modules comprises a case management module configured to facilitate secure cloud-based communication of the arbitration related data between the users and further configured to facilitate the users to conduct an automated online arbitration proceeding by performing cloud computing on the arbitration related data and the one or more predetermined rules employing cloud computing components.

In an embodiment, the cloud computing components include at least two servers located in separate jurisdictions, each jurisdiction being neutral to all parties to arbitration.

In an embodiment, the selection of servers located in neutral jurisdictions is based on the predetermined rules or are selected by parties to arbitration.

In an embodiment, the cloud computing components comprises of databases for arbitration data, the databases being located in separate jurisdictions, each jurisdiction being neutral to all parties to arbitration.

In an embodiment, the selection of databases located in neutral jurisdictions is based on the predetermined rules or are selected by parties to arbitration.

In an embodiment of the present invention, the case management module is configured to receive a request for conducting arbitration for a dispute case from a first party user and further configured to store data related to the dispute case in the cloud-based repository. In another embodiment of the present invention, the one or more virtual arbitration modules comprise a rule engine in communication with the case management module and configured to retrieve the one or more predetermined rules from the cloud-based repository for conducting the arbitration proceeding. In yet another embodiment of the present invention, the case management module is configured to automatically send notice of arbitration to a second party user using cloud-based communication. In an embodiment of the present invention, the case management module is configured to automatically evaluate response to the notice of arbitration received from the second party user. The case management module is further configured to automatically appoint a sole arbitrator or an arbitral tribunal based on the one or more predetermined rules retrieved from the cloud-based repository. In another embodiment of the present invention, the case management module in communication with the rule engine is configured to automatically send arbitration hearing request to the first party user, the second party user and the appointed sole arbitrator user or arbitral tribunal users based on the one or more predetermined rules retrieved from the cloud-based repository.

In an embodiment of the present invention, the one or more virtual arbitration modules comprises a payment module in communication with the case management module and configured to facilitate cloud-based payment transaction between the users and the virtual arbitration centre.

In another embodiment of the present invention, the one or more virtual arbitration modules comprises a telepresence module in communication with the case management module and configured to facilitate the users to participate in a cloud-based online arbitration hearing.

In an embodiment of the present invention, the case management module in communication with the rule engine is configured to generate and transmit an arbitration award to the users.

In another embodiment of the present invention, the data related to arbitration comprises at least one of: user data, data provided by users to the virtual arbitration centre, arbitration proceeding related data and arbitration case data.

In yet another embodiment of the present invention, the cloud-based arbitration service is accessed by the users via one or more electronic devices in telepresence centers at remote locations.

A method for performing automated arbitration proceeding over a communication network via a virtual arbitration centre in a cloud computing environment is provided. The method comprises the steps of providing, by the virtual arbitration centre, a cloud-based arbitration service to users at remote locations over the communication network. The method further comprises the steps of accessing the cloud-based arbitration service via a web-based user interface on the users' electronic devices. The cloud-based arbitration service comprises storing one or more predetermined rules and arbitration related data in a cloud-based repository. The method further comprises performing cloud-based communication of the arbitration related data between the users. Further, the method comprises conducting a cloud-based automated arbitration proceeding using the arbitration related data and the one or more predetermined rules.

In an embodiment of the present invention, performing cloud-based communication of arbitration related data between the users comprises receiving request for conducting an arbitration proceeding for a dispute case from a first party user. The dispute case is assigned a unique case number. The method further comprises automatically sending notice of arbitration to a second party user. Further, the method comprises automatically evaluating response to the notice of arbitration received from the second party user based on the one or more predetermined rules retrieved from the cloud-based repository for appointing one or more arbitrators. Further, the method comprises automatically retrieving arbitration related data stored in the cloud-based repository using the assigned unique case number. The method further comprises conducting online arbitration hearing between at least the first and second party users and the appointed one or more arbitrators employing the retrieved data and the one or more predetermined rules. Furthermore, the method comprises providing arbitration award to the first and second parties based on the arbitration hearing.

The method also comprises selecting at least two servers located in separate jurisdictions, each jurisdiction being neutral to all parties to arbitration.

In an embodiment, the selection of servers located in neutral jurisdictions is based on the predetermined rules or are selected by parties to arbitration.

The method may further comprise selecting databases for arbitration data, the databases being located in separate jurisdictions, each jurisdiction being neutral to all parties to arbitration.

In an embodiment, the selection of databases located in neutral jurisdictions is based on the predetermined rules or are selected by parties to arbitration.

In an embodiment of the present invention, performing cloud-based communication of arbitration related data between the users comprises facilitating payment transactions between the users and the virtual arbitration centre. The method further comprises facilitating the users to upload one or more documents to the virtual arbitration centre after verifying payment made by the users.

In another embodiment of the present invention, automatically evaluating the response from the second party user based on one or more predetermined rules for appointing one or more arbitrators comprises automatically determining if the second party user has responded to the notice of arbitration within a predetermined time period based on the one or more predetermined rules. The method further comprises automatically appointing sole arbitrator or an arbitral tribunal nominated by the first and second party users based on the one or more predetermined rules if the second party user has responded within the predetermined time period.

In an embodiment of the present invention, automatically evaluating the response from the second party user based on the one or more predetermined rules for appointing one or more arbitrators comprises automatically determining if the second party user has not responded to the notice of arbitration within a predetermined time period based on the one or more predetermined rules. The method further comprises automatically retrieving a list of arbitrators stored in the cloud-based repository for appointing a sole arbitrator or an arbitral tribunal.

In an embodiment of the present invention, automatically evaluating the response from the second party user based on the one or more predetermined rules for appointing one or more arbitrators comprises automatically determining if the second party user has responded to the notice of arbitration within a predetermined time period based on the one or more predetermined rules. The method further comprises automatically analyzing the response received from the second party user. Further, the method comprises automatically retrieving a list of arbitrators stored in the repository for appointing a sole arbitrator or an arbitral tribunal if it is determined that the second party user has not agreed to the first party's preference of sole arbitrator or arbitral tribunal as indicated in an agreement stored in the cloud-based repository.

In an embodiment of the present invention, conducting online arbitration includes hearing between at least the first and second party users and the appointed one or more arbitrators comprises conducting online arbitration hearing between at least the first and second party users and the appointed one or more arbitrators via telepresence.

In another embodiment of the present invention, the arbitration related data comprises at least one of: user data, data provided by users to the virtual arbitration centre, arbitration proceeding related data and arbitration case data.

### BRIEF DESCRIPTION OF THE ACCOMPANYING DRAWINGS

The present invention is described by way of embodiments illustrated in the accompanying drawings wherein:

FIG. 1 is a block diagram of a system for performing secure online arbitration proceedings in a communication network, in accordance with an embodiment of the present invention;

FIG. 2 is a block diagram of a system for performing secure online arbitration proceedings in a communication network, in accordance with an embodiment of the present invention; and

FIGS. 3A and 3B illustrate a flowchart of a method for performing secure online arbitration proceedings in a communication network via a virtual arbitration centre, in accordance with an embodiment of the present invention.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For the purpose of clarity, details relating to technical material that is known in the technical fields related to the invention have been briefly described or omitted so as not to unnecessarily obscure the present invention.

The present invention would now be discussed in context of embodiments as illustrated in the accompanying drawings.

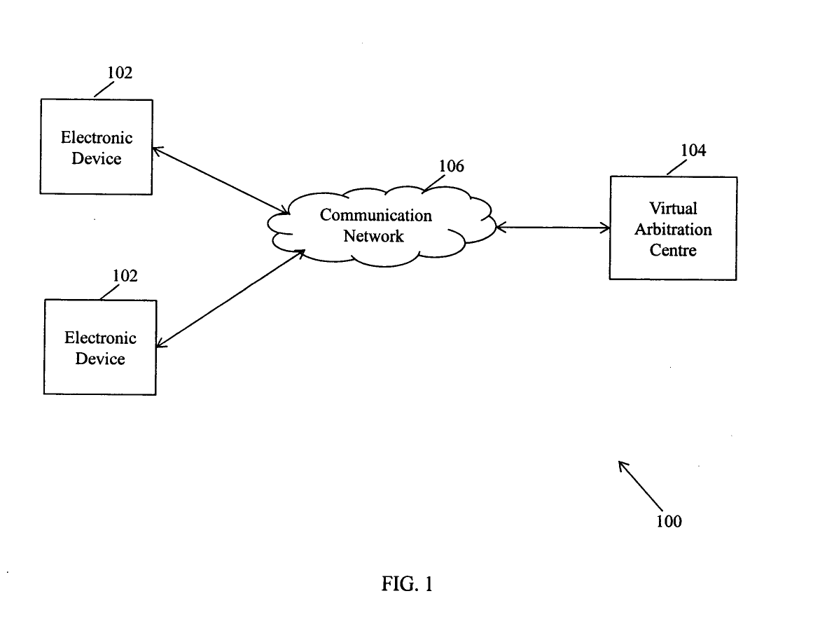

FIG. 1 is a block diagram of a system for performing secure online arbitration proceedings in a communication network, in accordance with an embodiment of the present invention. The system 100 comprises a plurality of electronic devices 102 and a virtual arbitration centre 104. The electronic devices 102 communicate with the virtual arbitration centre 104 over a communication network 106.

Electronic devices 102 include various communication devices which may be used by one or more users to access the virtual arbitration centre 104 over the communication network 106. In various exemplary embodiments of the present invention, the electronic devices 102 include, but are not limited to, laptop, netbook, tablet, mobile phone, Personal Digital Assistant (PDA), Personal Computer (PC) and any other handheld computing device. In an embodiment of the present invention, the users may include one or more parties and their appointed advocates or lawyers involved in dispute and seeking arbitration. In another embodiment of the present invention, the users may include one or more arbitrators who are appointed as a neutral party for resolving the dispute using the virtual arbitration process. In yet another embodiment of the present invention, the users may include one or more witnesses associated with the one or more parties.

In various embodiments of the present invention, one or more users may access the virtual arbitration centre 104 via electronic devices 102 over a communication network 106 from telepresence centres. The telepresence centres may be provided in different jurisdictions. The telepresence centres provide the one or more users secure and high speed access to arbitration proceedings conducted via the virtual arbitration centre 104.

The virtual arbitration centre 104 includes one or more virtual arbitration modules which provide virtual arbitration service to the users and the users carry out the arbitration proceedings via the electronic devices 102 over the communication network 106. In an embodiment of the present invention, the virtual arbitration centre 104 may be implemented in a cloud computing environment where data from the one or more virtual arbitration modules of the virtual arbitration centre 204 are provided to the electronic devices 102 over the communication network 106 for carrying out arbitration proceedings. The virtual arbitration centre 104 facilitates conducting domestic and international arbitrations in an automated manner from any part of the world without requiring parties or arbitrators to travel to a common destination or being physically present at any one or more locations. The virtual arbitration centre 204 also facilitates overcoming restrictions that are imposed for carrying out arbitration due to varied nationalities of parties and arbitrators. In the cloud computing environment at least two servers are provided and located in separate jurisdictions. This could obviate a territorial linkage to any one jurisdiction. Servers may be selected for an arbitration proceeding in jurisdictions neutral to all parties to arbitration. The selection of servers located in neutral jurisdictions may be based on predetermined rules or may be selected by parties to arbitration. In like fashion, databases for evidence and other arbitration data may also be located in separate jurisdictions and selection may be based on predetermined rules or by parties to arbitration. The predetermined rules can provide for selection of a plurality of servers and databases, each in a separate jurisdiction.

The communication network 106 may include a high speed network which facilitates one or more electronic devices 102 to securely access data in the cloud computing environment. The cloud computing environment comprises various cloud computing components such as servers, databases, virtual servers, virtual databases, nodes etc. In various exemplary embodiments of the present invention, the communication network 106 may include internet, high speed 3G technologies such as Enhanced Data for Global Evolution (EDGE), High-Speed Packet Access (HSPA), wireless network capable of data exchange such as General Packet Radio Service (GPRS), Evolution Data Optimized (EvDO), Long-Term Evolution (LTE), Worldwide Interoperability for Microwave Access (WiMAX), Wireless Fidelity (WiFi), intranet and any other type of wired or wireless network. In various embodiments of the present invention, all the transactions conducted via the virtual arbitration centre 104 are performed by employing various encryption technologies including, but not limited to, Secured Sockets Layer (SSL), HTTP Secure etc.

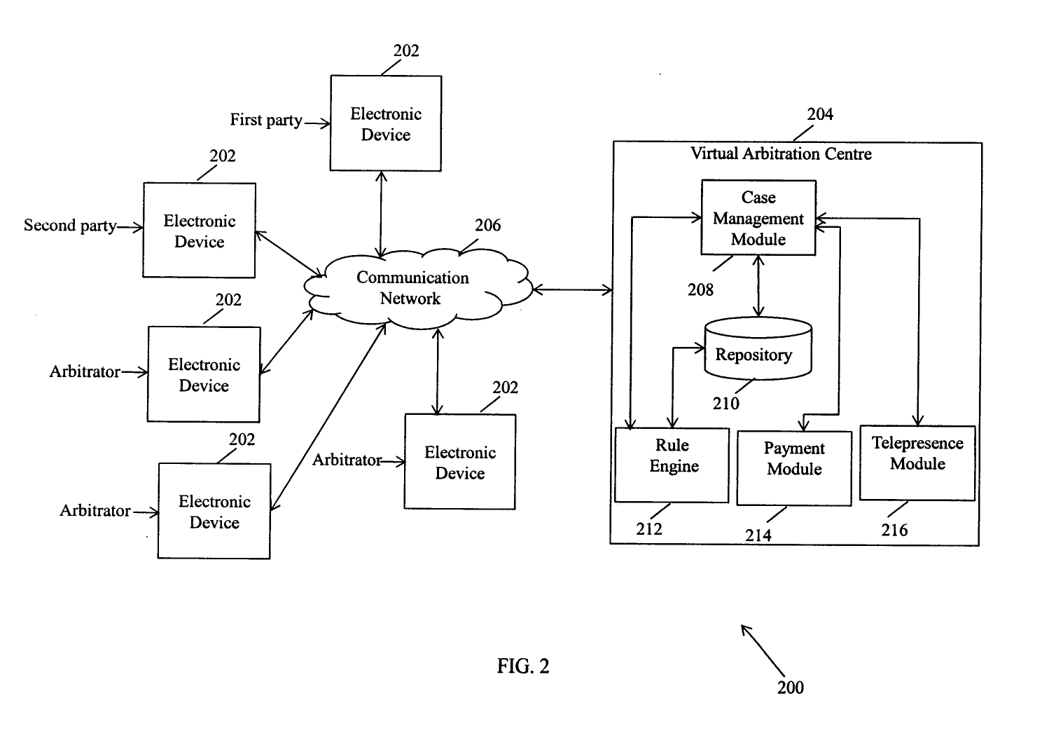

FIG. 2 is a detailed block diagram of a system for performing secure online arbitration proceedings in a communication network, in accordance with an embodiment of the present invention. The system 200 comprises electronic devices 202 which communicate with a virtual arbitration centre 204 via a communication network 206. The virtual arbitration centre 204 provides a virtual arbitration service to the users via virtual arbitration modules. The virtual arbitration service is a cloud-based arbitration service. The virtual arbitration modules comprise a case management module 208, a repository 210, a rule engine 212, a payment module 214 and a telepresence module 216.

In an embodiment of the present invention, the virtual arbitration centre 204 in a cloud computing environment is implemented as a front-end component and a back-end component. The front-end component is visible to the electronic devices 202 and includes a graphical user interface such as a web-based graphical user interface for accessing the one or more virtual arbitration modules in the back-end component. The back-end component (also referred to as cloud) comprises various cloud computing components which execute the one or more virtual arbitration modules of the virtual arbitration centre 204 and perform cloud computing on data related to arbitration. In an embodiment of the present invention, all communication between the users and the virtual arbitration centre 204 are cloud based. The cloud computing components include, but are not limited to, servers, virtual servers, nodes, cloud databases, virtual cloud databases etc. Cloud database is a non relational database which stores and manages huge sets of data of the virtual arbitration centre 204 in a distributed manner. Examples of cloud databases may include Amazon Simple DB, Apache Couch DB or any other document oriented key-value database. The cloud database may comprise a processing engine for handling storage and retrieval of the huge datasets.

In an embodiment of the present invention, parties (e.g. first party and second party) involved in a dispute may designate the virtual arbitration centre 204 in their agreement as the online centre for resolving disputes between the parties via arbitration. The parties may also designate the virtual arbitration centre 204 after a dispute has arisen. The agreement includes a dispute resolution clause which, inter alia, states that disputes, if any, are to be resolved by the virtual arbitration centre 204. In an embodiment of the present invention, the parties may register with the virtual arbitration centre 204 and may provide their agreement to the virtual arbitration centre 204 for storage and reference subject to confidentiality requirements which are to be carried out by the virtual arbitration centre 204. The virtual arbitration centre 204 may provide unique registration number to the parties for future reference. The virtual arbitration centre 204 facilitates conducting online arbitration proceedings based on the one or more rules provided by the virtual arbitration centre 204. Further, electronic mail addresses and other information associated with the parties may be stored within the virtual arbitration centre 204.

In an embodiment of the present invention, the electronic devices 202 are provided with web-based graphical user interface using which the parties, arbitrators and others access the virtual arbitration service and participate in arbitration proceedings which is conducted via the virtual arbitration centre 204. In an exemplary embodiment of the present invention, the first party initiates arbitration process by clicking a ‘dispute’ button or a hyperlink provided in the web-based graphical user interface. The first party may also select type of dispute by selecting an option from a drop down list in a combo box which is provided in the web-based graphical user interface. The case management module 208 in the virtual arbitration centre 204 is a software module which is configured to receive request for dispute resolution from the first party's electronic device 202. The case management module 208, then, generates authentication information such as user identification (id) and password corresponding to the first party and stores the authentication information in the repository 210. The case management module 208 further assigns a case number to the dispute and stores the case number in the repository 210. All further arbitration proceedings for the dispute is conducted by referring to the case number and registration number. In an embodiment of the present invention, the repository 210 is a cloud-based repository.

In an embodiment of the present invention, the first party sends a notice of arbitration to the second party via the virtual arbitration centre 204 once a case number is allotted. In an exemplary embodiment of the present invention, the first party uploads the notice by clicking a button or a hyperlink marked ‘notice’ provided in the web-based graphical user interface. The case management module 208 receives the notice and facilitates to send the notice to the second party. In an exemplary embodiment of the present invention, the case management module 208 may send the notice to the second party via electronic mail. The electronic mail addresses of the second party may be retrieved from the repository 210. The case management module 208 also stores a copy of the notice in the repository 210.

In an exemplary embodiment of the present invention, the case management module 208 determines if the second party has not responded to the notice within a predetermined time period. The predetermined time period is based on one or more rules specified by the virtual arbitration centre 204 and retrieved by the rule engine 212 from the repository 210. The rule engine 212 is a software module configured to operate in conjunction with the case management module 208. The case management module 208, in consultation with the parties, facilitates to appoint arbitral tribunal based on agreement and one or more rules of the virtual arbitration centre 204. The arbitral tribunal may include a sole arbitrator or a panel of three arbitrators. In an embodiment of the present invention, appointment of arbitral tribunal may be governed by the agreement where the parties indicate their preference for selecting either a sole arbitrator or a three member panel of arbitrators. The agreement is retrieved from the repository 210. In another embodiment of the present invention, if the agreement does not indicate any information about arbitral tribunal, one or more rules of the virtual arbitration centre 204 may be employed for appointing the arbitral tribunal.

The one or more rules may also include the case management module 208 appointing a sole or three member panel of arbitrators based on a list of arbitrators provided in the repository 210. Further, the one or more rules may include the case management module 208 requesting the first party and the second party to indicate preference for selecting one or more arbitrators via electronic mail. After receiving the preferences from the parties, the case management module 208 may select a third arbitrator. The case management module 208 may also request the appointed arbitrators to select a third arbitrator.

In another exemplary embodiment of the present invention, the case management module 208 determines if the second party has responded within the predetermined time but the second party has not agreed to the first party's preference of arbitral tribunal as indicated in the agreement. The case management module 208 then facilitates to appoint arbitration tribunal based on one or more rules of the virtual arbitration centre 204. In yet another exemplary embodiment of the present invention, the case management module 208 determines if the second party has responded within the predetermined time and the second party has agreed to the first party's preference of arbitral tribunal as indicated in the agreement. The case management module 208 facilitates to appoint arbitration tribunal based on the parties preference which is indicated in the agreement stored in the repository 210.

In an embodiment of the present invention, after the arbitral tribunal is appointed, the case management module 208 sends hearing request to parties, arbitrators and other involved via electronic mail. The hearing request may include, but is not limited to, date and time for conducting hearing. The date and time of hearing may be determined by the rule engine 212 based on one or more rules provided by the virtual arbitration centre 204.

In another embodiment of the present invention, one or more reminders for hearing may be sent to the parties based on one or more rules retrieved by the rule engine 212 from the repository 210. The case management module 208 may use calendaring software to determine one or more dates for sending reminders to the parties, and scheduling software to set reminders on predetermined dates for sending hearing request to the parties, arbitrators and others via electronic mail. The electronic addresses of the arbitrators may be stored in the repository 210.

In an embodiment of the present invention, the case management module 208 monitors payment of requisite fees by the parties via the payment module 214. The fee details related to arbitration proceeding may be stored in the repository 210. In an exemplary embodiment of the present invention, the payment module 214 may include a payment gateway that facilitates online transaction securely between the payer (e.g. parties) and payee (e.g. virtual arbitration centre).

In an exemplary embodiment of the present invention, if payment has been made by the first party, the first party is enabled to upload documents such as statement of claims and other supporting documents into the virtual arbitration centre 204. In an exemplary embodiment of the present invention, the first party uploads the documents using ‘document’ button in the web-based graphical user interface of the electronic device 202. The case management module 208 receives the documents from the first party's electronic device 202 and stores the documents in the repository 210.

In another exemplary embodiment of the present invention, if payment has been made by the second party, the second party is enabled to upload documents such as statement of defense and other supporting documents. In another exemplary embodiment of the present invention, the second party uploads the documents using ‘document’ button in the web-based graphical user interface of the electronic device 202. The case management module 208 receives the documents from the second party's electronic device 202 and stores the documents in the repository 210. In yet another exemplary embodiment of the present invention, the parties upload affidavits of evidences of witnesses and the case management module 208 receives and stores the affidavits of evidences in the repository 210.

In an embodiment of the present invention, the case management module 208 further generates and sends respective authentication details such as user name and passwords of the parties, arbitrators and witnesses via respective email addresses to attend the hearing. In another embodiment of the present invention, appropriate access rights are set by the virtual arbitration centre 204 to allow restricted access to parties and arbitrators.

In an embodiment of the present invention, the parties and the arbitrators etc. access the virtual arbitration centre 204 on the date of hearing at a designated time for attending hearing. In an exemplary embodiment of the present invention, the parties, arbitrators, witnesses etc. attend hearing by logging in via a telepresence program in respective electronic devices 202 using respective authentication details. In another exemplary embodiment of the present invention, parties, arbitrators, witnesses etc. attend hearing from telepresence centres via a telepresence program using respective authentication details.

The case management module 208 facilitates hearing to be conducted via a telepresence module 216. The telepresence module 216 is a software module which facilitates conducting hearing session in real time. The hearing session may be recorded and transcribed in the repository 210.

In various embodiments of the present invention, the case management module 208 generates and transmits arbitration award to the parties. The arbitration award is a document that describes decision related to the dispute made by arbitrator tribunal. The document is a confidential document which includes digital signatures of the arbitrator (s). The case management module 208 is configured to operate with the rule engine 212 to determine the date of sending the arbitration award to the first party and the second party.

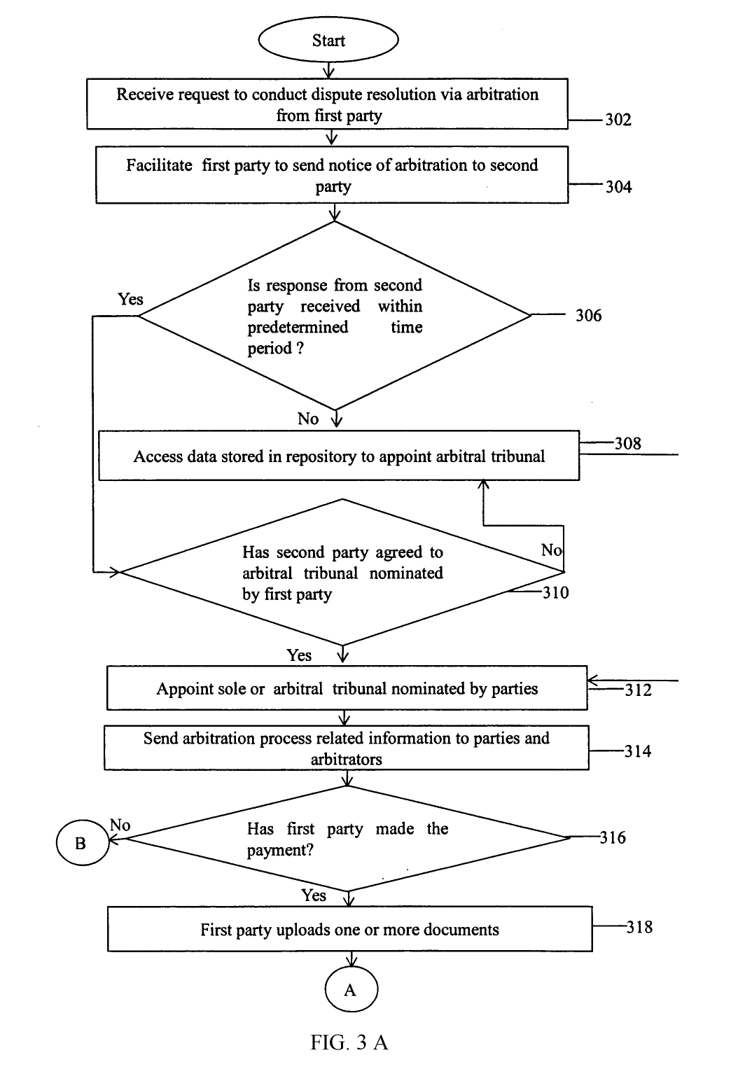

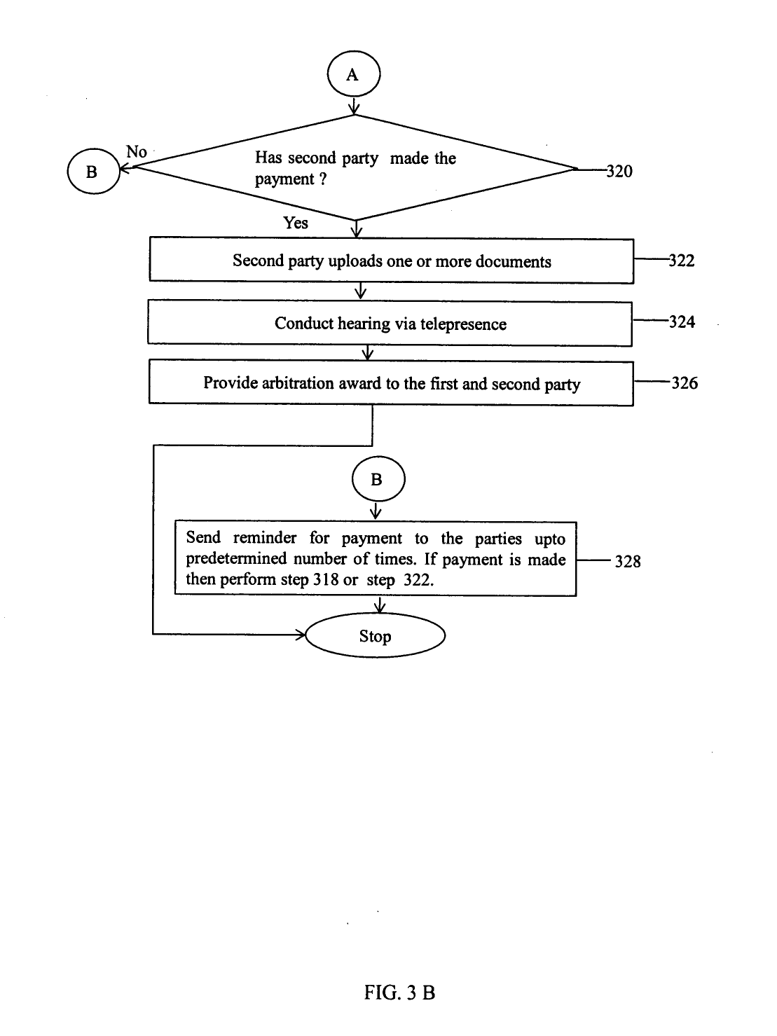

FIGS. 3A and 3B illustrates an exemplary flowchart of a method for performing alternative dispute resolution processes employing a communication network via a virtual arbitration centre, in accordance with an embodiment of the present invention.

In various embodiments of the present invention, parties (e.g. first party and second party) designate the virtual arbitration centre as an online centre for resolving one or more disputes between the parties in an agreement. The parties register with the virtual arbitration centre and receive unique registration numbers. The agreement, electronic addresses and other information associated with the parties may be made available to the virtual arbitration centre and stored in a repository of the virtual arbitration centre.

At step 302, request for conducting dispute resolution via arbitration is received from a first party. In an exemplary embodiment of the present invention, the first party sends a request to commence dispute resolution using an electronic device. This triggers a request for initiating an arbitration proceeding to the virtual arbitration centre for resolving dispute between the parties. In another exemplary embodiment of the present invention, the parties may send the request via electronic mail to the virtual arbitration centre. In another embodiment of the present invention, the request may be initiated by the first party using a button or a hyperlink in the web-based interface of the first party's electronic device.

At step 304, first party is facilitated to send notice of arbitration to the second party. In an exemplary embodiment of the present invention, the first party may upload the notice into the virtual arbitration centre using an electronic device. The virtual arbitration centre facilitates the first party to send the notice to the second party using electronic mail address of the second party. The virtual arbitration centre stores a copy of the notice in the repository. The virtual arbitration centre retrieves the electronic mail address of the second party from the repository and automatically sends the notice to the second party. In an embodiment of the present invention, any known software may be used for performing automatic communication between the users and the virtual arbitration centre.

In an embodiment of the present invention, authentication details corresponding to the first party and second party is generated by the virtual arbitration centre and stored in the repository. The authentication details include username and password. Further, the virtual arbitration centre assigns a unique case number to the dispute case and stores the unique case number in the repository. The unique case number is referred for conducting arbitration proceeding of the case.

At step 306, a check is performed to determine if response to the notice has been received within a predetermined time period. In an exemplary embodiment of the present invention, the predetermined time period may be specified in one or more rules provided by the virtual arbitration centre.

If it is determined that the second party has not responded within a predetermined time period, then, at step 308, data stored in the repository is accessed to appoint an arbitral tribunal. In an exemplary embodiment of the present invention, data may include procedure for appointing arbitrator which is stated in the agreement stored in the repository. The procedure may include the parties preference of arbitral tribunal. In case the party's preference is not indicated in the agreement, the virtual arbitration centre may appoint sole arbitrator or a three member arbitral tribunal based on one or more rules provided by virtual arbitration centre. A list of arbitrators may be provided by the virtual arbitration centre.

In another exemplary embodiment of the present invention, the data may include one or more arbitration rules provided by the virtual arbitration centre for appointing an arbitral tribunal. The virtual arbitration centre may appoint a sole arbitrator based one or more arbitration rules. In another embodiment of the present invention, the virtual arbitration centre may appoint a three member tribunal based on one or more arbitration rules.

If it is determined that the second party has responded within a predetermined time period, then, at step 310, a check is performed to determine if the second party has agreed to the arbitral tribunal indicated in the agreement. If it is determined that the second party has agreed, then, at step 312 the virtual arbitration centre appoints the arbitral tribunal based on the agreement.

If it is determined that the second party has not agreed to the arbitral tribunal indicated in the agreement, then, the virtual arbitration centre appoints arbitral tribunal based on one or more rules as described with respect to step 308. In an embodiment of the present invention, the second party may raise objections pertaining to the nature of dispute indicated by the first party in the notice of arbitration. As described in step 308, the virtual arbitration centre appoints the arbitral tribunal and the objections may be raised before the one or more arbitrator.

At step 314, arbitration process related information is sent to the parties and arbitrators. In an embodiment of the present invention, arbitration process related information includes information related to the appointment of arbitral tribunal which is sent to the parties and arbitrators via electronic mail. In another embodiment of the present invention, arbitration process related information includes information related to hearing between the parties and the arbitrator which may be based on one or more rules provided by the virtual arbitration centre. Hearing related information may include, but is not limited to, date of hearing, time of hearing which is sent to the parties via electronic mail. In an embodiment of the present invention, the hearing related information is sent before the date of hearing which is based on one or more rules. In another embodiment of the present invention, the hearing date may be adjourned from time to time up to a predetermined time which is based on one or more rules. In an embodiment of the present invention, the arbitration process related information is stored in the repository and is retrieved for automatically sending to the parties and arbitrators.

In an embodiment of the present invention, the authentication details i.e. username and password and case number that is generated are also sent to the parties via respective email addresses. In another embodiment of the present invention, authentication details such as user name and passwords of the one or more arbitrators are also generated and sent to the one or more arbitrators via respective email addresses. In an embodiment of the present invention, user data is stored in the repository and is retrieved for automatically sending to the users.

At step 316, a check is performed to determine if the first party has made the payment. If it is determined that the first party has made the payment, then, at step 318, the first party is authorized to upload one or more documents into the virtual arbitration centre using the first party's electronic device. The uploaded documents may be stored in the repository in the virtual arbitration centre. In an exemplary embodiment of the present invention, the one or more documents include statement of claim of the first party along with other supporting documents. In an embodiment of the present invention, the first party uploads affidavits of evidence. The evidence may include, but not limited to, text, audio information, video information etc. In an embodiment of the present invention, appropriate access rights are assigned to each of the uploaded documents for maintaining confidentiality. In another embodiment of the present invention, a list of witnesses may also be uploaded which provide information regarding the witness such as name, photograph, email address, bio-metric details etc. and subject-matter the witnesses would testify. The list of witnesses may be stored in the repository. In an embodiment of the present invention, identification details of the witnesses may be generated by the virtual arbitration centre and sent to the witnesses via respective email addresses. The authentication details may also be stored in the repository.

If it is determined that the first party has not made the payment, then, at step 328, reminder for payment is sent to the first party based on one or more rules provided by the virtual arbitration centre. If payment is made then step 318 is performed.

At step 320, a check is performed to determine if the second party has made the payment. If it is determined that the second party has made the payment, then, at step 320, the second party is authorized to upload one or more documents into the virtual arbitration centre using the second party's electronic device. The uploaded documents are stored in a repository in the virtual arbitration centre. In an exemplary embodiment of the present invention, the one or more documents include statement of defense of the second party along with counter claims, rejoinders etc. In an embodiment of the present invention, the second party uploads affidavits of evidence. The evidence may include, but is not limited to, text, audio information, video information etc. In an embodiment of the present invention, appropriate access rights are assigned to each of the uploaded documents for maintaining confidentiality. In another embodiment of the present invention, a list of witnesses may also be uploaded which provide information regarding the witness such as name, photograph, email address, biometric details etc. and subject-matter the witnesses would testify. The list of witnesses may be stored in the repository. If it is determined that the second party has not made the payment, then, at step 328, reminder for payment is sent to the second party up to a predetermined number of times which is based on one or more rules provided by the virtual arbitration centre. If payment is made then step 320 is performed.

In an embodiment of the present invention, authentication details of the witnesses may be generated by the virtual arbitration centre and mailed to the witnesses via respective email addresses. The identification details may also be stored in the repository.

At step 324, hearing is conducted via telepresence. In an embodiment of the present invention, the parties and one or more arbitrators may log into a videoconferencing program either from telepresence centres or respective electronic devices at the predetermined date and time and hearing may be conducted to decide the case and settle the dispute. In an embodiment of the present invention, during the hearing, parties address oral arguments based on uploaded documents (statement of claims, statement of defense, affidavits of witnesses etc.) and cross-examination of witnesses. In another embodiment of the present invention, the arbitrators may pose questions to the parties, which may be replied by the parties during the course of this hearing or during a next hearing.

In an embodiment of the present invention, the hearing proceedings may be recorded and transcribed. The hearing proceedings may be video recorded and audio recorded and stored in the repository. Oral communication between the parties and the one or more arbitrators may be transcribed into text using any known voice recognition software and stored in the repository in a printable format. In another embodiment of the present invention, the hearing proceedings may also be translated to English language and stored in the repository. In an embodiment of the present invention, the hearing proceeding may also include cross-examination of witnesses. The witnesses may also log in using unique user id and password into a videoconferencing program provided in associated electronic devices.

At step 326, an arbitration award is provided to the first party and second party via the virtual arbitration centre. In an embodiment of the present invention, the arbitration award may be rendered on the web based user interface of the first and second party within a predetermined number of days based on one or more rules provided by the virtual arbitration centre. In an embodiment of the present invention, the arbitration award is a document that describes the decision of arbitral tribunal. The document is a confidential document which includes digital signatures of the one or more arbitrators. Appropriate access rights may be set to protect the document from public viewing.

The present invention may be implemented in numerous ways including as a apparatus, method, or a computer program product such as a computer readable storage medium or a computer network wherein programming instructions are communicated from a remote location.

Various embodiments of the present invention, may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

I claim:

1. A system for facilitating users to perform automated arbitration proceeding over a communication network via a virtual arbitration centre, the system comprising:
one or more virtual arbitration modules configured to provide users at remote locations access to the virtual arbitration centre via a web-based user interface on the users' electronic devices, wherein the one or more virtual arbitration modules comprises:
a cloud-based repository configured to store one or more predetermined rules and data related to arbitration; and
a case management module configured to facilitate secure communication of the arbitration related data between the users and further configured to facilitate the users to conduct an automated online arbitration proceeding using the data related to arbitration and the one or more predetermined rules.

2. A system for facilitating users to perform automated arbitration proceeding over a communication network via a virtual arbitration centre in a cloud computing environment, the system comprising:
one or more virtual arbitration modules in the virtual arbitration centre configured to provide cloud-based arbitration service over the communication network to users at remote locations;
one or more electronic devices configured to facilitate the users to access the cloud-based virtual arbitration service via a web-based user interface on the one or more electronic devices,
wherein the one or more virtual arbitration modules comprises:
a cloud-based repository configured to store one or more predetermined rules and data related to arbitration; and
a case management module configured to facilitate secure cloud-based communication of the arbitration related data between the users and further configured to facilitate the users to conduct an automated online arbitration proceeding by performing cloud computing on the arbitration related data and the one or more predetermined rules employing cloud computing components.

3. The system of claim 2, wherein the cloud computing components include at least two servers located in separate jurisdictions, each jurisdiction being neutral to all parties to arbitration.

4. The system of claim 3, wherein selection of servers located in neutral jurisdictions is based on the predetermined rules or are selected by parties to arbitration.

5. The system of claim 2, wherein the cloud computing components comprise of databases for arbitration data, the databases being located in separate jurisdictions, each jurisdiction being neutral to all parties to arbitration.

6. The system of claim 5, wherein selection of databases located in neutral jurisdictions is based on the predetermined rules or are selected by parties to arbitration.

7. The system of claim 2, wherein the case management module is configured to receive a request for conducting arbitration for a dispute case from a first party user and further configured to store data related to the dispute case in the cloud-based repository.

8. The system of claim 2, wherein the one or more virtual arbitration modules comprise a rule engine in communication with the case management module and configured to retrieve the one or more predetermined rules from the cloud-based repository for conducting the arbitration proceeding.

9. The system of claim 7, wherein the case management module is configured to automatically send notice of arbitration to a second party user using cloud-based communication.

10. The system of claim 9, wherein the case management module is configured to:
automatically evaluate response to the notice of arbitration received from the second party user; and
automatically appoint a sole arbitrator or an arbitral tribunal based on the one or more predetermined rules retrieved from the cloud-based repository.

11. The system of claim 10, wherein the case management module in communication with the rule engine is configured to automatically send arbitration hearing request to the first party user, the second party user and the appointed sole arbitrator user or arbitral tribunal users based on the one or more predetermined rules retrieved from the cloud-based repository.

12. The system of claim 2, wherein the one or more virtual arbitration modules comprises a payment module in communication with the case management module and configured to facilitate cloud-based payment transaction between the users and the virtual arbitration centre.

13. The system of claim 2, wherein the one or more virtual arbitration modules comprises a telepresence module in communication with the case management module and configured to facilitate the users to participate in a cloud-based online arbitration hearing.

14. The system of claim 2, wherein the case management module in communication with the rule engine is configured to generate and transmit an arbitration award to the users.

15. The system of claim 2, wherein the data related to arbitration comprises at least one of: user data, data provided by users to the virtual arbitration centre, arbitration proceeding related data and arbitration case data.

16. The system of claim 2, wherein the cloud-based arbitration service is accessed by the users via one or more electronic devices in telepresence centers at remote locations.

17. A method for performing automated arbitration proceeding over a communication network via a virtual arbitration centre in a cloud computing environment, the method comprising the steps of
providing, by the virtual arbitration centre, a cloud-based arbitration service to users at remote locations over the communication network;
accessing the cloud-based arbitration service via a web-based user interface on the users' electronic devices, wherein the cloud-based arbitration service comprises:
storing one or more predetermined rules and arbitration related data in a cloud-based repository;
performing cloud-based communication of the arbitration related data between the users; and
conducting a cloud-based automated arbitration proceeding using the arbitration related data and the one or more predetermined rules.

18. The method of claim 17, wherein performing cloud-based communication of arbitration related data between the users comprises:
receiving request for conducting an arbitration proceeding for a dispute case from a first party user, wherein the dispute case is assigned a unique case number;
automatically sending notice of arbitration to a second party user;
automatically evaluating response to the notice of arbitration received from the second party user based on the one or more predetermined rules retrieved from the cloud-based repository for appointing one or more arbitrators;
automatically retrieving arbitration related data stored in the cloud-based repository using the assigned unique case number;
conducting online arbitration hearing between at least the first and second party users and the appointed one or more arbitrators employing the retrieved data and the one or more predetermined rules; and
providing arbitration award to the first and second parties based on the arbitration hearing.

19. The method of claim 18 further comprising selecting at least two servers located in separate jurisdictions, each jurisdiction being neutral to all parties to arbitration.

20. The method of claim 19, wherein selection of servers located in neutral jurisdictions is based on the predetermined rules or are selected by parties to arbitration.

21. The method of claim 18 further comprising selecting databases for arbitration data, the databases being located in separate jurisdictions, each jurisdiction being neutral to all parties to arbitration.

22. The method of claim 21, wherein selection of databases located in neutral jurisdictions is based on the predetermined rules or are selected by parties to arbitration.

23. The method of claim 17, wherein performing cloud-based communication of arbitration related data between the users comprises:
facilitating payment transactions between the users and the virtual arbitration centre; and
facilitating the users to upload one or more documents to the virtual arbitration centre after verifying payment made by the users.

24. The method of claim 18, wherein automatically evaluating the response from the second party user based on one or more predetermined rules for appointing one or more arbitrators comprises:
automatically determining if the second party user has responded to the notice of arbitration within a predetermined time period based on the one or more predetermined rules; and
automatically appointing sole arbitrator or an arbitral tribunal nominated by the first and second party users based on the one or more predetermined rules if the second party user has responded within the predetermined time period.

25. The method of claim 18, wherein automatically evaluating the response from the second party user based on the one or more predetermined rules for appointing one or more arbitrators comprises:
automatically determining if the second party user has not responded to the notice of arbitration within a predetermined time period based on the one or more predetermined rules; and
automatically retrieving a list of arbitrators stored in the cloud-based repository for appointing a sole arbitrator or an arbitral tribunal.

26. The method of claim 18, wherein automatically evaluating the response from the second party user based on the one or more predetermined rules for appointing one or more arbitrators comprises:
automatically determining if the second party has responded to the notice of arbitration within a predetermined time period based on the one or more predetermined rules;
automatically analyzing the response received from the second party user; and
automatically retrieving a list of arbitrators stored in the repository for appointing a sole arbitrator or an arbitral tribunal if it is determined that the second party user has not agreed to the first party's preference of sole arbitrator or arbitral tribunal as indicated in an agreement stored in the cloud-based repository.

27. The method of claim 18, wherein facilitating to conduct online arbitration hearing between at least the first and second party users and the appointed one or more arbitrators comprises:
conducting online arbitration hearing between at least the first and second party users and the appointed one or more arbitrators via telepresence.

28. The method of claim 17, wherein the arbitration related data comprises at least one of: user data, data provided by users to the virtual arbitration centre, arbitration proceeding related data and arbitration case data.
